(19) United States
(12) Patent Application Publication
(10) Pub. No.: US 2026/0096870 A1
(43) Pub. Date: Apr. 9, 2026

(54) ORTHODONTIC PLATE HAVING A PAIR OF EXTENDED HOOKS

(71) Applicant: KING SAUD UNIVERSITY, RIYADH (SA)

(72) Inventors: ALI SALEH ALJHANI, RIYADH (SA); LAMA AHMED ALKAHLAN, RIYADH (SA)

(21) Appl. No.: 18/965,075

(22) Filed: Dec. 2, 2024

Related U.S. Application Data
(63) Continuation of application No. 29/966,928, filed on Oct. 7, 2024, now Pat. No. D1110508.

(51) Int. Cl. A61C 7/36

(52) U.S. Cl. CPC A61C 7/36

(57) ABSTRACT

An orthodontic plate includes a base, a stem, a first arm, a first hook, a second arm and a second hook. The base, the stem, the first arm, the first hook, the second arm and the second hook may be integrally formed with one another. The base that can be affixed to the buccal side of a patient's mouth via a plurality of titanium screws. The stem extends from the base. The first and second arms extend from the stem in a mirrored configuration. Each hook is connected to a distal end of a respective arm. Each hook is configured to be connected to a wire, a spring, a chain, etc., that applies a tensile force or a compressive force to a tooth. The stem, the first arm and/or the second arm can be bent to provide a more comfortable fit in a patient's mouth.

### CROSS-REFERENCE TO RELATED APPLICATION

This patent applications claims priority under 35 U.S.C. § 120 to U.S. Design Application Ser. No. 29/966,928, filed in the U.S.P.T.O. on Oct. 7, 2024, the disclosure of which is incorporated by reference herein in its entirety.

### TECHNICAL FIELD

The present disclosure relates to orthodontia, and more particularly, to an orthodontic plate having a pair of extended hooks.

### DISCUSSION OF THE RELATED ART

Orthodontic plates are small metal plates used for correcting orthodontic problems, such as properly aligning teeth in a patient's mouth. An orthodontic plate acts as a structural support point to which a wire, a spring, etc., is connected for pulling or pushing a tooth. In order to provide sufficient structural support for its intended purpose, an orthodontic plate is generally affixed to a portion of the patient's mouth via screws that anchor in bone. However, known orthodontic plates have limited applications.

### SUMMARY

The present disclosure relates to an orthodontic plate usable to provide a cost-effective and efficient orthodontic treatment, and to provide flexibility via its bilateral hook design. The pair of hooks extending from the two arms of the plate allow for the application of different forces on the plate from different directions. For example, each one of the two hooks can support a spring, a chain, a wire, etc., that pushes or pulls on the hook from a given direction with a certain magnitude. Therefore, a plate of the present disclosure allows for a versatile way of repositioning teeth, including single and segmental teeth movement.

A plate of the present disclosure has a low likelihood of failure, eliminates treatment complications associated with rigid miniplates, provides anchorage in both vertical and horizontal directions, and simplifies the process of aligning teeth properly by doing away with the need to insert multiple means of anchorage in a patient's mouth (since one plate of the present disclosure can serve as anchorage for two or more wires, springs, etc., that apply forces of different magnitudes (or of the same magnitude) on the plate from different directions).

Significantly, the arms and/or stem of a plate of the present subject matter can be bent intra-orally to better suit the anatomy of the receiving patient. The bendability of the stem and/or arms of the plate of the present disclosure can reduce discomfort in the patient and improve the results of the orthodontic treatment.

### BRIEF DESCRIPTION OF THE DRAWINGS

The above and other features of the present disclosure will become more apparent by describing in detail exemplary embodiments thereof in conjunction with the accompanying drawings, in which:

FIG. 1 is a perspective view illustrating an orthodontic plate of the present disclosure; and

FIG. 2 is a front view illustrating the orthodontic plate of FIG. 1.

### DETAILED DESCRIPTION OF THE EMBODIMENTS

Exemplary embodiments of the present disclosure will be described more fully hereinafter with reference to the accompanying drawings. The present disclosure may, however, be embodied in different forms and should not be construed as being limited to the embodiments set forth herein. Like reference numerals may refer to like elements throughout the specification. The sizes and/or proportions of the elements illustrated in the drawings may be exaggerated for clarity.

When an element is referred to as being disposed on another element, intervening elements may be disposed therebetween. In addition, elements, components, parts, etc., not described in detail with respect to a certain figure or embodiment may be assumed to be similar to or the same as corresponding elements, components, parts, etc., described in other parts of the specification.

Throughout the application, where compositions are described as having, including, or comprising specific components, or where processes are described as having, including, or comprising specific process steps, it is contemplated that compositions of the present teachings can also consist essentially of, or consist of, the recited components, and that the processes of the present teachings can also consist essentially of, or consist of, the recited process steps.

It is noted that, as used in this specification and the appended claims, the singular forms “a”, “an”, and “the” may include plural references unless the context clearly dictates otherwise.

In the application, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a composition or a method described herein can be combined in a variety of ways without departing from the spirit and scope of the present teachings, whether explicit or implicit herein.

The use of the terms “include,” “includes”, “including,” “have,” “has,” or “having” should be generally understood as open-ended and non-limiting unless specifically stated otherwise.

The use of the singular herein includes the plural (and vice versa) unless specifically stated otherwise. In addition, where the use of the term “about” is before a quantitative value, the present teachings also include the specific quantitative value itself, unless specifically stated otherwise. As used herein, the term “about” refers to a ±10% variation from the nominal value unless otherwise indicated or inferred.

The term “optional” or “optionally” means that the subsequently described event or circumstance may or may not occur, and that the description includes instances where said event or circumstance occurs and instances in which it does not.

Unless defined otherwise, all technical and scientific terms used herein have the same meaning as commonly understood to one of ordinary skill in the art to which the presently described subject matter pertains.

Where a range of values is provided, for example, concentration ranges, percentage ranges, or ratio ranges, it is understood that each intervening value, to the tenth of the unit of the lower limit, unless the context clearly dictates otherwise, between the upper and lower limit of that range and any other stated or intervening value in that stated range, is encompassed within the described subject matter. The upper and lower limits of these smaller ranges may independently be included in the smaller ranges, and such embodiments are also encompassed within the described subject matter, subject to any specifically excluded limit in the stated range. Where the stated range includes one or both of the limits, ranges excluding either or both of those included limits are also included in the described subject matter.

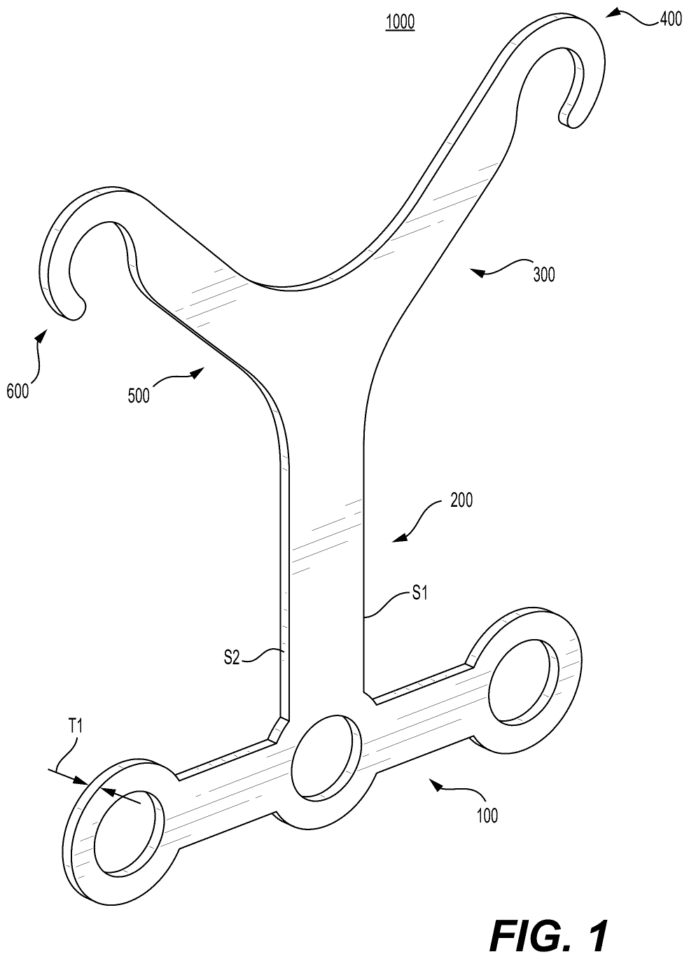

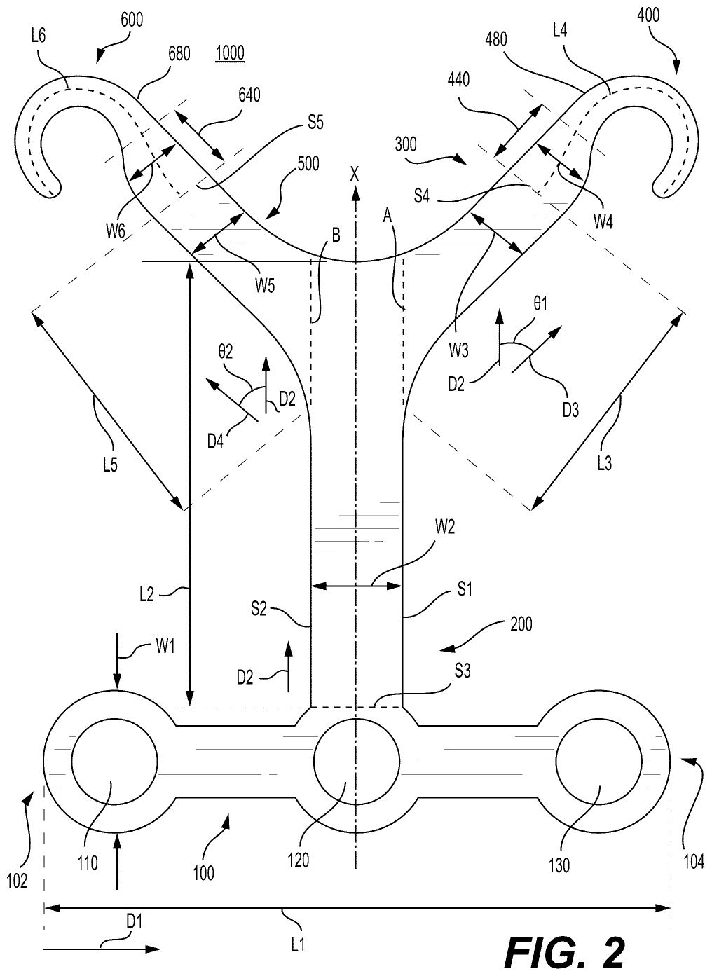

FIGS. 1-2 illustrate an orthodontic plate 1000 according to the present disclosure. The plate 1000 may also be referred to as an orthodontic mini plate due to its small size. For example, and without limitation, the orthodontic mini plate 1000 may have an overall width of about 16.8 mm across its base, an overall length of about 19.9 2 mm (from the base to the hooks), and a thickness that is appreciably smaller than its length or width. It is understood that these dimensions may be varied as needed depending on the anatomy of a patient. The orthodontic mini plate 1000 is configured to be selectively attached to the buccal side of the oral cavity of a patient via a plurality (e.g., three) fasteners. The fasteners may be surgical-grade titanium screws.

Referring to FIGS. 1-2, the orthodontic plate 1000 includes a base 100, a stem 200, a first arm 300, a first hook 400, a second arm 500 and a second hook 600. The base 100, the stem 200, the first arm 300, the first hook 400, the second arm 500 and the second hook 600 may be integrally formed with one another. For example, the orthodontic plate 1000 may be formed by machining a sheet of metal into the shape illustrated in FIGS. 1-2.

The metal forming the sheet may be, for example, titanium (e.g., surgical grade titanium). Alternatively, or in addition, the metal sheet may include gold, surgical grade stainless steel, other metals considered to be safe or nonreactive with bodily tissue, or an alloy thereof.

The base 100 has a first end 102, a second end 104 opposite to the first end 102, a first length L1 extending in a first direction D1 between the first and second ends 102, 104, and a first width W1 and a first thickness T1 (see FIG. 1) along the first length thereof.

The stem 200, the first arm 300, the first hook 400, the second arm 500 and the second hook 600 may have substantially the same thickness as the base 100 since all said components of the orthodontic plate 1000 may be formed from the same sheet of metal (it is presumed that a “sheet” of metal has a unform thickness throughout).

The base 100 includes a first through hole 110, a second through hole 120 and a third through hole 130, each of which penetrating the base 100 in a direction of the first thickness T1. The first to third through holes 110-130 are spaced apart from one another. The base 100 has a first side surface S3 (see FIG. 2) in its thickness direction, the first side surface S3 being defined by a portion of the first length L1 and the first thickness T1 of the base 100.

As illustrated in FIG. 2, the first to third through holes 110-130 may be arranged in-line with one another. The second through hole 120 may disposed in the middle of the first length L1 of the base 100. The first through hole 110 may be disposed adjacent to the first end 102 of the base 100. The third through hole 130 may be disposed adjacent to the second end 104 of the base 100. In addition, a spacing between the first and second through holes 110, 120 may be equal to a spacing between the second and third through holes 120, 130.

Referring to FIG. 2, the stem 200 extends from the first side surface S3 of the base 100 in a second direction D2, substantially perpendicular to the first direction D1. The stem 200 has a second length L2 in the second direction D2, and a second width W2 and a second thickness (substantially equal to thickness T1) along the second length L2.

The stem 200 has a first side surface S1 and a second side surface S2, opposite to the first side surface S1. The first side surface S1 of the stem 200 is defined by the second length L2 and the second thickness of the stem 200. The second side surface S2 of the stem 200 is defined by the second length L2 and the second thickness of the stem 200.

The first arm 300 extends from the first side surface S1 of the stem 200 in a third direction D3. Specifically, line A in FIG. 2 illustrates a portion of the first side surface S1 which the first arm 300 extends from. The second and third directions D2, D3 form an acute angle θ1 with one another. The first arm 300 has a third length L3 extending in the third direction D3, and a third width W3 and a third thickness (substantially equal to thickness T1) along the third length L3.

The first arm 300 has a first end side surface S4 defined by the third width W3 and the third thickness of the first arm 300. The first end side surface S4 is distal from the stem 200.

As illustrated in FIG. 2, the third width W3 of the first arm 300 increases toward the stem 200. That is, the firm arm 300 becomes wider in a direction toward the stem 200 (relative to the first end side surface S4).

The first hook 400 is connected to the first arm 300 at the first end side surface S4 of the first arm 300. The first hook has a fourth length LA (measured along the dashed line illustrated in FIG. 2), and a fourth width W4 and a fourth thickness (substantially equal to thickness T1) along the fourth length LA.

The first hook 400 has a first hook portion 440 and a second hook portion 480. The first hook portion 440 is arranged between the first arm 300 and the second hook portion 480. The second hook portion 480 is curved. As illustrated in FIG. 2, the fourth width W4 of the first hook 400 decreases along the first hook portion 440 in the third direction D3.

The second arm 500 extends from the second side surface S2 of the stem 200 in a fourth direction D4. Specifically, line B in FIG. 2 illustrates a portion of the second side surface S2 which the second arm 500 extends from. The second and fourth directions D2, D4 form an acute angle θ2 with one another. Referring to FIG. 2, the fourth direction D4 mirrors the third direction D3 about an imaginary axis X that passes through a middle of the stem 200 in the length direction (i.e., L2) of the stem 200. Therefore, the first and second arms 300, 500 may be mirror opposites of one another.

The second arm 500 has a fifth length L5 extending in the fourth direction D4, and a fifth width W5 and a fifth thickness (substantially equal to thickness T1) along the fifth length thereof L5.

The second arm 500 has a second end side surface S5 defined by the fifth width W5 and the fifth thickness of the second arm 500. The second end side surface S5 is distal from the stem 200.

Referring to FIG. 2, the fifth width W5 of the second arm 500 increases toward the stem 200. That is, the second arm 500 becomes wider in a direction toward the stem 200 (relative to the second end side surface S5).

As illustrated in FIG. 2, the stem 200 may be longer than the first arm 300 and longer than the second arm 500.

The second hook 600 is connected to the second arm 500 at the second end side surface S5 of the second arm 500. The second hook 600 has a sixth length L6, and a sixth width W6 and a sixth thickness (substantially equal to thickness T1) along the sixth length L6.

Referring to FIG. 2, second hook 600 has a third hook portion 640 and a fourth hook portion 680. The third hook portion 640 is arranged between the second arm 500 and the fourth hook portion 680. The fourth hook portion 680 is curved. The sixth width W6 of the third hook 600 decreases along the third hook portion 640 in the fourth direction D4.

With reference to FIG. 2, the first and second hooks 400, 600 may be mirror opposites of one another.

The orthodontic plate 1000 can be attached to the buccal portion of a patient's mouth via three anchoring screws. The screws can be made of surgical grade titanium. The stem 200, the first arm 300 and/or the second arm 500 can be bent, based on the anatomy of a patient's mouth, to provide a comfortable fit for the patient while each one of the first and second hooks 400, 600 can be used as an anchoring point for supporting a wire, a spring, a chain, etc., that is subjected to tension or compression to reposition a tooth. The wire, spring, chain, etc., connected to the first hook 400 may apply a force in a different direction (and/or of a different magnitude) than the wire, spring, chain, etc., connected to the second hook 600. Therefore, the orthodontic plate 600 has a wide applicability in correcting orthodontic problems.

While the present disclosure has been particularly shown and described with reference to exemplary embodiments thereof, it will be apparent to those of ordinary skill in the art that various changes in form and detail may be made therein without departing from the spirit and scope of the present disclosure as defined by the following claims.

1. An orthodontic plate, comprising:
a base having a first end, a second end opposite to the first end, a first length extending in a first direction between the first and second ends thereof, and a first width and a first thickness along the first length thereof, wherein the base includes first to third through holes, each of which penetrating the base in a direction of the first thickness, the first to third through holes being spaced apart from one another, and wherein the base has a first side surface defined by a portion of the first length and the first thickness thereof,
a stem extending from the first side surface of the base in a second direction, substantially perpendicular to the first direction, wherein the stem has a second length in the second direction, and a second width and a second thickness along the second length thereof, wherein the stem has a first side surface and a second side surface, opposite to the first side surface, wherein the first side surface of the stem is defined by the second length and the second thickness thereof, and wherein the second side surface of the stem is defined by the second length and the second thickness thereof;
a first arm extending from the first side surface of the stem in a third direction, the second and third directions forming an acute angle with one another, wherein the first arm has a third length extending in the third direction, and a third width and a third thickness along the third length thereof, the first arm having a first end side surface defined by the third width and the third thickness thereof, the first end side surface being distal from the stem;
a first hook connected to the first arm at the first end side surface of the first arm, wherein the first hook has a fourth length, and a fourth width and a fourth thickness along the fourth length thereof;
a second arm extending from the second side surface of the stem in a fourth direction, the fourth direction mirroring the third direction about an imaginary axis that passes through a middle of the stem in the second direction, wherein the second arm has a fifth length extending in the fourth direction, and a fifth width and a fifth thickness along the fifth length thereof, the second arm having a second end side surface defined by the fifth width and the fifth thickness thereof, the second end side surface being distal from the stem; and
a second hook connected to the second arm at the second end side surface of the second arm, wherein the second hook has a sixth length, and a sixth width and a sixth thickness along the sixth length thereof;
wherein the first to third through holes are arranged in-line with one another in the horizontal, vertical, and sagittal planes;
wherein the first to third through holes are flat holes with a uniform thickness; and
wherein an axis passes through a middle of the stem and a distance between the axis and the first hook is the same length as the distance between the axis and the second hook, the distance between the axis and the first through hole, and the distance between the axis and the third through hole.

2. The orthodontic plate of claim 1, wherein the base, the stem, the first arm, the first hook, the second arm and the second hook are integrally formed with one another.

3. The orthodontic plate of claim 2, wherein the base, the stem, the first arm, the first hook, the second arm and the second hook are formed of titanium.

4. The orthodontic plate of claim 1, wherein the third width of the first arm increases toward the stem.

5. The orthodontic plate of claim 4, wherein the fifth width of the second arm increases toward the stem.

6. The orthodontic plate of claim 5, wherein the first hook has a first hook portion and a second hook portion, wherein the first hook portion is arranged between the first arm and the second hook portion, and wherein the second hook portion is curved.

7. The orthodontic plate of claim 6, wherein the fourth width of the first hook decreases along the first hook portion in the third direction.

8. The orthodontic plate of claim 7, wherein the second hook has a third hook portion and a fourth hook portion, wherein the third hook portion is arranged between the second arm and the fourth hook portion, and wherein the fourth hook portion is curved.

9. The orthodontic plate of claim 8, wherein the sixth width of the second hook decreases along the third hook portion in the fourth direction.

10. The orthodontic plate of claim 9, wherein the first and second arms are mirror opposites of one another.

11. The orthodontic plate of claim 10, wherein the first and second hooks are mirror opposites of one another.

12. The orthodontic plate of claim 1, wherein the stem is longer than the first arm and longer than the second arm.

13. (canceled)

14. The orthodontic plate of claim 1, wherein a spacing between the first and second through holes is equal to a spacing between the second and third through holes.

15. The orthodontic plate of claim 14, wherein the second through hole is disposed in a middle of the first length of the base, wherein the first through hole is disposed adjacent to the first end of the base, and wherein the third through hole is disposed adjacent to the second end of the base.
